(19) United States
(12) Patent Application Publication
(10) Pub. No.: US 2026/0058307 A1
(43) Pub. Date: Feb. 26, 2026

(54) SEPARATOR FOR LITHIUM-SULFUR BATTERY, LITHIUM-SULFUR BATTERY COMPRISING THE SEPARATOR, AND METHOD OF MANUFACTURING THE SEPARATOR

(71) Applicants: LG ENERGY SOLUTION, LTD., Seoul (KR); SEOUL NATIONAL UNIVERSITY R&DB FOUNDATION, Seoul (KR)

(72) Inventors: Soo-Hyun KIM, Daejeon (KR); Jong-Chan LEE, Seoul (KR); Ki-Hyun KIM, Daejeon (KR); Kwon-Nam SOHN, Daejeon (KR); Chan-Yeong KOONG, Seoul (KR); Da-Un JEONG, Seoul (KR); Dong-Gi HONG, Seoul (KR)

(21) Appl. No.: 19/105,698

(22) PCT Filed: Aug. 30, 2023
(86) PCT No.: PCT/KR2023/012929

§ 371 Date: Feb. 21, 2025

(30) Foreign Application Priority Data
Aug. 31, 2022 (KR) 10-2022-0110367

(51) Int. Cl. H01M 50/449; H01M 10/052; H01M 50/403; H01M 50/423; H01M 50/489

(52) U.S. Cl. CPC H01M 50/449; H01M 10/052; H01M 50/403; H01M 50/423; H01M 50/489

(57) ABSTRACT

A separator for a lithium-sulfur battery, a lithium-sulfur battery comprising the separator, and a method of manufacturing the separator are provided. The separator comprises a porous polymer substrate and a coating layer on at least one surface of the porous polymer substrate, the coating layer comprising a polyamic acid compound having a carboxylic acid group and an amide group, wherein a mole ratio of the carboxylic acid group to the amide group is 1:0.5 to 1:5.

### CROSS-REFERENCE TO RELATED APPLICATION

This application is a National Phase entry pursuant to 35 U.S.C. § 371 of International Application No. PCT/KR2023/012929 filed on August 30, and claims priority to Korean Patent Application No. 10-2022-0110367 filed on Aug. 31, 2022 in the Republic of Korea, the disclosure of which is incorporated herein by reference.

### FIELD

The present disclosure relates to a separator capable of suppressing migration of polysulfide eluted from a positive electrode to increase the life and a secondary battery comprising the same.

### BACKGROUND

With the technology development and growing demand for mobile devices, there is a growing demand for secondary batteries as an energy source, and among secondary batteries, lithium secondary batteries are brought to market and being widely used due to high energy density and working potential, long cycle life and low self-discharge rate.

Recently, with the rising interest in environmental issues, many studies are being conducted on electric vehicles (EV) and hybrid electric vehicles (HEV) as an alternative to vehicles using fossil fuels such as gasoline vehicles and diesel vehicles that are regarded as one of the main causes of air pollution. Lithium secondary batteries having high energy density, high discharge voltage and output stability are mainly studied and used as a power source of electric vehicles and hybrid electric vehicles.

Lithium secondary batteries have a structure in which an electrode assembly includes a positive electrode and a negative electrode, each electrode including an electrode current collector and an active material coated on the electrode current collector, with a porous separator disposed between the positive electrode and the negative electrode, and a nonaqueous electrolyte comprising a lithium salt is wetted to the electrode assembly.

At the present time, the lithium secondary battery market is governed by technology based on pairing of lithium cobalt oxide LiCoO2 at the positive electrode and graphite at the negative electrode. The rated voltage of lithium secondary batteries is about 3.6V, while the rated voltage of most of other types of batteries (Ni—Cd, Ni-MH, etc.) is 1.5V. The energy density per volume and the energy density per mass are about 300 to 500 Wh/l and 160 to 200 Wh/kg, respectively. This value is the highest value among all the batteries now in the market. Additionally, this type of batteries has low self-discharge and long life (500 or 1000 cycles). Despite the surprising performance achievement, there is not much difference in performance between all the current lithium ion batteries, and it is foreseen that improvement will take place only to a very limited extent.

Accordingly, lithium-sulfur (Li—S) batteries are emerging as an alternative to the known lithium ion batteries.

In the same way as lithium ion secondary batteries, lithium-sulfur batteries work by lithium ions moving in the electrolyte between the positive electrode and the negative electrode. However, since lithium-sulfur batteries simply use sulfur, as opposed to lithium ion secondary batteries designed to store energy by intercalation reaction of lithium ions into molecules of the electrode active material, inducing changes in electrode structure, lithium-sulfur batteries work based on oxidation and reduction reaction between sulfur and lithium ions. Accordingly, compared to lithium ion secondary batteries, lithium-sulfur batteries may have theoretically higher capacity at the equal volume without limitations on the electrode structure. Due to this feature, in lithium-sulfur batteries comprising the sulfur positive electrode and the lithium metal negative electrode, when it is assumed that elemental sulfur (Ss) having ring structure is completely reduced to lithium polysulfide (Li₂S), the theoretical capacity is 1,675 mAh/g and the theoretical energy density is 2,600 Wh/kg that are higher 3 times to 6 times than the existing other battery systems (Ni/MH batteries: 450 Wh/kg, Li/FeS: 480 Wh/kg, Li/MnO₂: 1,000 Wh/kg, Na/S: 800 Wh/kg).

On the other hand, the existing transition metal oxide based lithium ion secondary batteries may be thought to be batteries comprising materials that are the sources of heavy metal contamination since they comprise oxides of nickel (Ni), cobalt (Co) and manganese (Mn) having higher density than the density of heavy metal (5 g/mL or more of metal) in the positive electrode. However, lithium-sulfur batteries are free of materials causing contamination and comprise nontoxic materials, and from this perspective, they are considered to be eco-friendly. Additionally, the positive electrode material, sulfur, is abundant on Earth and inexpensive.

Meanwhile, in lithium-sulfur batteries, reduction reaction of sulfur and oxidation reaction of lithium metal occurs during discharging, and in this instance, sulfur forms lithium polysulfide (LiPS) of linear structure from Ss of ring structure, and lithium-sulfur batteries show stepwise discharge voltage until the lithium polysulfide is completely reduced to Li₂S. However, while lithium-sulfur batteries are charged/discharged, charge/discharge efficiency reduces and battery life degrades. As described above, life degradation of lithium-sulfur batteries is caused by many different factors such as side reaction of electrolyte solutions, instability of lithium metal, and accumulation of positive electrode by-products (for example, elution of lithium polysulfide from the positive electrode).

That is, in lithium-sulfur batteries using the sulfur based compound for the positive electrode active material and alkaline metal such as lithium for the negative electrode active material, elution of lithium polysulfide occurs during charging/discharging, and the lithium polysulfide eluted from the positive electrode migrates to the negative electrode, which reduces the capacity of the lithium-sulfur batteries and shortens the life of the lithium-sulfur batteries. That is, since the lithium polysulfide eluted from the positive electrode has high solubility in the electrolyte solution, unintended migration of the lithium polysulfide to the negative electrode through the separator via the electrolyte solution may occur, thereby causing irreversible loss of the positive electrode active material and the consequential capacity fading, and sulfur particle accumulation on lithium metal surface induced by side reaction, resulting in shorter battery life.

To solve the life reduction problem caused by lithium polysulfide, in the technical field, studies have been conducted on the addition of lithium polysulfide absorbent materials to the positive electrode composite or reaction mitigating materials to the negative electrode to prevent side reaction on lithium metal surface, but did not produce meaningful outcomes.

### SUMMARY

An embodiment of the present disclosure is directed to providing a separator capable of preventing elution and migration of lithium polysulfide from a positive electrode to a negative electrode to improve the life of a lithium-sulfur battery.

Another embodiment of the present disclosure is directed to providing a lithium-sulfur battery comprising the separator.

Still another embodiment of the present disclosure is directed to providing a method of manufacturing the separator.

Additionally, it will be easily understood that these and other objectives and advantages of the present disclosure can be realized by the means or methods set forth in the appended claims and their combination.

To solve the above-described problem of the present disclosure, there are provided a separator, a lithium-sulfur battery comprising the separator and a method of manufacturing the separator according to the following embodiments.

According to a first embodiment, there is provided the separator for a lithium-sulfur battery, the separator comprising a porous polymer substrate having a plurality of pores; and a coating layer on at least one surface of the porous polymer substrate, the coating layer comprising a polyamic acid compound having a carboxylic acid group and an amide group, wherein a mole ratio of the carboxylic acid group to the amide group is 1:0.5 to 1:5.

According to a second embodiment, in the first embodiment, the mole ratio of the carboxylic acid group to the amide group may be 1:0.75 to 1:3.

According to a third embodiment, in the first or second embodiment, the polyamic acid compound may be a polymer having a unit having the carboxylic acid group and the amide group as a repeating unit.

According to a fourth embodiment, in any one of the first to third embodiments, a molar concentration of the carboxylic acid group may be 5 mmol/L to 15 mmol/L, and a molar concentration of the amide group may be 8 mmol/L to 20 mmol/L.

According to a fifth embodiment, in any one of the first to fourth embodiments, the polyamic acid compound may be an aromatic polyamic acid compound.

According to a sixth embodiment, in any one of the first to fifth embodiments, a polydispersity index (PDI) of the polyamic acid may be 2.6 to 3.2.

According to a seventh embodiment, in any one of the first to sixth embodiments, the polyamic acid compound having the carboxylic acid group and the amide group may be present in the pores of the porous polymer substrate.

According to an eighth embodiment, there is provided the lithium-sulfur battery comprising a positive electrode, a negative electrode, and a separator between the positive electrode and the negative electrode, wherein the separator is the separator for the lithium-sulfur battery according to any one of the first to sixth embodiments.

According to a ninth embodiment, there is provided the method of manufacturing a separator for a lithium-sulfur battery, comprising preparing a porous polymer substrate having a plurality of pores; and forming a coating layer comprising a polyamic acid compound having a carboxylic acid group and an amide group on at least one surface of the porous polymer substrate, wherein forming the coating layer comprising the polyamic acid compound comprises dipping the porous polymer substrate in a first solution comprising a carboxylic dianhydride compound; and dipping the porous polymer substrate having been dipped in the first solution in a second solution comprising a diamine compound, and wherein a mole ratio of the carboxylic acid group to the amide group is 1:0.5 to 1:5.

According to a tenth embodiment, in the ninth embodiment, the polyamic acid compound may be placed in the plurality of pores simultaneously when the coating layer of the polyamic acid compound is formed on the at least one surface of the porous polymer substrate.

According to an eleventh embodiment, in the ninth or tenth embodiment, the mole ratio of the carboxylic acid group to the amide group may be 1:0.75 to 1:3.

According to a twelfth embodiment, in any one of the ninth to eleventh embodiments, an amount of the carboxylic dianhydride compound in the first solution may be 0.2 wt % to 3 wt %, and an amount of the diamine compound in the second solution may be 0.2 wt % to 3 wt %.

According to a thirteenth embodiment, in any one of the ninth to twelfth embodiments, the carboxylic acid group may be derived from the carboxylic dianhydride compound, and the amide group may be derived from the diamine compound.

According to a fourteenth embodiment, in the thirteenth embodiment, the carboxylic dianhydride compound may comprise 3,3′,4,4′-benzophenone tetracarboxylic dianhydride, 3,3′,4,4′-diphenyltetracarboxylic dianhydride, 3,3′,4,4′-diphenylsulfonetetracarboxylic dianhydride, 2,2-bis [4-(3,4-dicarboxyphenoxy)phenyl]propane dianhydride, 1,2,3,4-benzenetetracarboxylic dianhydride, methylcyclohexene tetracarboxylic dianhydride, naphthalene-1,4,5,8-tetracarboxylic dianhydride, ethylenetetra carboxylic dianhydride, or two or more thereof, and the diamine compound may comprise p-phenylene diamine, m-phenylene diamine, 2,2′-bis(trifluoromethyl)-4,4′-biphenyldiamine, 2,2′-dimethyl-4,4′-diaminobenzidine, 4,4′-diaminodiphenyl sulfone, 2,7-diaminofluorene, 4,4-diaminooctafluorobiphenyl, 4,4′-oxydianiline, 2,2′-dimethyl-4,4′-diaminobiphenyl, m-xylylenediamine, p-xylylenediamine, 4,4′-diaminobenzanilide, or two or more thereof.

According to a fifteenth embodiment, in any one of the ninth to fourteenth embodiments, dipping the porous polymer substrate in the first solution and dipping the porous polymer substrate in the second solution may be each performed for 40 minutes to 80 minutes.

According to a sixteenth embodiment, in the fifteenth embodiment, the method of manufacturing the separator for the lithium-sulfur battery, after dipping the porous polymer substrate in the second solution, may further comprise: cleaning the porous polymer substrate; and drying the cleaned porous polymer substrate in a vacuum.

The separator for the lithium-sulfur battery according to the embodiments of the present disclosure has the coating layer comprising the polyamic acid compound on at least one surface of the porous polymer substrate by dipping the porous polymer substrate in the first solution comprising the carboxylic dianhydride compound and then the second solution comprising the diamine compound. The polyamic acid compound comprises the carboxylic acid group and the amide group, and the mole ratio of the carboxylic acid group to the amide group is 1:0.5 to 1:5. Since the separator has the coating layer comprising the polyamic acid compound, it may be possible to prevent migration of lithium polysulfide eluted from the positive electrode of the lithium-sulfur battery to the negative electrode. Accordingly, it may be possible to prevent sulfur particle accumulation on the lithium metal surface of the negative electrode, thereby maintaining the charge/discharge capacity of the lithium-sulfur battery and improving the battery life.

Additionally, the polyamic acid of the coating layer is made via in-situ polymerization. The carboxylic dianhydride compound in a monomolecular state is first supplied to the porous polymer substrate, so the carboxylic dianhydride compound may be coated into the pores of the porous polymer substrate. Subsequently, the diamine compound is supplied, causing polymerization reaction in the pores, so the polyamic acid compound may be coated into the pores. Additionally, it may be possible to reduce the interfacial resistance between the coating layer and the porous polymer substrate, thereby achieving higher electrochemical performance.

### BRIEF DESCRIPTION OF THE DRAWINGS

The accompanying drawings illustrate exemplary embodiments of the present disclosure and together with the following detailed description, serve to provide a further understanding of the technical aspect of the present disclosure, and thus the present disclosure should not be construed as being limited to the drawings.

FIG. 1 is a diagram illustrating a method of manufacturing a separator for a lithium-sulfur battery according to an embodiment of the present disclosure.

FIG. 2 is a diagram illustrating a method of manufacturing a separator for a lithium-sulfur battery according to example 1.

FIGS. 3 and 4 are graphs showing discharge capacity of lithium-sulfur batteries comprising separators for lithium-sulfur batteries obtained through a manufacturing method according to examples of the present disclosure and separators for lithium-sulfur batteries according to comparative examples.

FIGS. 5 and 6 are images showing thermal stability evaluation results of separators according to example 1 and comparative example 1.

FIG. 7 is a graph showing determination of suppression of polysulfide elution of separators according to example 1 and comparative example 1.

### DETAILED DESCRIPTION

Hereinafter, the present disclosure will be described in more detail.

It should be understood that the terms or words used in the specification and the appended claims should not be construed as limited to general and dictionary meanings, but rather interpreted based on the meanings and concepts corresponding to technical aspects of the present disclosure on the basis of the principle that the inventor is allowed to define terms appropriately for the best explanation.

The term “comprise(s)” or “include(s)” when used in this specification, specifies the presence of stated elements, but does not preclude the presence or addition of one or more other elements, unless the context clearly indicates otherwise.

The term “about” or “approximately” is used herein in the sense of at, or nearly at, when given the manufacturing and material tolerances inherent in the stated circumstances and is used to prevent the unscrupulous infringer from unfairly taking advantage of the present disclosure where exact or absolute figures are stated to help better understanding of the present disclosure.

The present disclosure relates to a separator, an electrochemical cell comprising the same and a method of manufacturing the same. In the present disclosure, the electrochemical cell may include any type of battery that generates electrochemical reaction. Specific examples of the electrochemical cell include any type of primary batteries, secondary batteries, fuel cells, solar cells and capacitors such as super capacitors, or the like. In particular, the electrochemical cell may be a secondary battery, and the secondary battery may be a lithium ion secondary battery. The lithium ion secondary battery may include, for example, a lithium-metal battery, a lithium-sulfur battery, an all-solid-state battery, a lithium polymer battery and so on, and among them, a lithium-sulfur battery is preferred.

Among secondary batteries, lithium-sulfur batteries have high discharge capacity and theoretical energy density, and since sulfur used as a positive electrode active material is abundant on Earth and inexpensive, lithium-sulfur batteries require low battery manufacturing costs and are eco-friendly, so they are gaining attention as the next-generation secondary battery.

In the present disclosure, the positive electrode active material comprises a carbon-sulfur composite, and the carbon-sulfur composite comprises a porous carbon material. In the lithium-sulfur battery, since the positive electrode active material, sulfur, is nonconductive, the carbon-sulfur composite, in which a conductive material, for example, a carbon material is combined with sulfur, is commonly used to improve electrical conductivity.

According to an aspect of the present disclosure, there is provided a separator for a lithium-sulfur battery, comprising:
a porous polymer substrate having a plurality of pores; and
a coating layer on at least one surface of the porous polymer substrate, the coating layer comprising a polyamic acid compound having a carboxylic acid group and an amide group,
wherein a mole ratio of the carboxylic acid group to the amide group is 1:0.5 to 1:5.

The porous polymer substrate is not limited to a particular type and may include any type of material that may be used as separator materials of electrochemical devices to electrically insulate the negative electrode from the positive electrode to prevent shorts and provide movement paths of lithium ions. The porous polymer substrate may include, for example, a porous polymer film or a nonwoven fabric comprising at least one of polymer resins such as polyolefin, polyethyleneterephthalate, polybutyleneterephthalate, polyacetal, polyamide, polycarbonate, polyimide, polyetheretherketone, polyethersulfone, polyphenylene oxide, polyphenylenesulfide and polyethylenenaphthalene.

The coating layer is located on at least one surface of the porous polymer substrate, and comprises the polyamic acid compound having the carboxylic acid group and the amide group. The carboxylic acid group may be derived from a carboxylic dianhydride compound, and the amide group may be derived from a diamine compound.

In the lithium-sulfur battery, reduction reaction of sulfur and oxidation reaction of lithium metal occurs during discharging, and in this instance, sulfur forms lithium polysulfide (LiPS) of linear structure from Ss of ring structure, and the lithium-sulfur battery shows stepwise discharge voltage until the lithium polysulfide is completely reduced to Li₂S.

However, during charging/discharging, charge/discharge efficiency of the lithium-sulfur battery reduces and the battery life degrades. As described above, life degradation of the lithium-sulfur battery is caused by many different factors such as side reaction of electrolyte solutions, instability of lithium metal, and accumulation of positive electrode by-products (for example, elution of lithium polysulfide from the positive electrode).

That is to say, in the lithium-sulfur battery using the sulfur based compound for the positive electrode active material and alkaline metal such as lithium for the negative electrode active material, elution of lithium polysulfide occurs during charging/discharging, and the lithium polysulfide eluted from the positive electrode migrates to the negative electrode, which reduces the capacity of the lithium-sulfur battery and shortens the life of the lithium-sulfur battery. That is to say, since the lithium polysulfide eluted from the positive electrode has high solubility in the electrolyte solution, the lithium polysulfide may unintentionally migrate to the negative electrode through the separator via the electrolyte solution, causing irreversible loss of the positive electrode active material and the consequential capacity fading, and sulfur particle accumulation on lithium metal surface induced by side reaction, resulting in shorter battery life.

To solve the life reduction problem caused by lithium polysulfide, in the technical field, studies have been conducted on the addition of lithium polysulfide absorbent materials to the positive electrode composite or reaction mitigating materials to the negative electrode to prevent side reaction on lithium metal surface, but did not produce meaningful outcomes.

Accordingly, to prevent the migration of lithium polysulfide eluted from the positive electrode to the negative electrode and accumulating on the surface of the negative electrode, the present disclosure discloses the separator for the lithium-sulfur battery having the coating layer comprising the polyamic acid compound having the carboxylic acid group and the amide group on at least one surface of the porous polymer substrate. Since the polyamic acid compound having the carboxylic acid group and the amide group is coated on the porous polymer substrate, it may be possible to prevent the migration of lithium polysulfide eluted from the positive electrode to the negative electrode, thereby improving the life of the lithium-sulfur battery.

According to an embodiment of the present disclosure, the coating layer comprising the polyamic acid compound may be formed on the porous polymer substrate, and the polyamic acid compound having the carboxylic acid group and the amide group may be present in the pores of the porous polymer substrate.

In an embodiment, the polyamic acid compound may be a polymer having a unit having the carboxylic acid group and the amide group as a repeating unit. Additionally, the polyamic acid compound may comprise an aromatic polyamic acid compound, an aliphatic polyamic acid compound and an aliphatic cyclic polyamic acid compound, and in the present disclosure, for more uniform and smooth coating on the porous polymer substrate, an aromatic polyamic acid compound having a phenol group capable of forming I-x bonds with the pores of the porous polymer substrate may be selected.

According to an embodiment of the present disclosure, the polyamic acid compound may include a chemical structure represented by the following Formula 1. Alternatively, the polyamic acid compound may include a repeating unit represented by the following Formula 1.

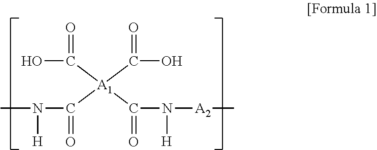

In the above Formula 1, A1 is a quadrivalent organic group having 1 to 20 carbon atoms, and A2 is a divalent organic group having 1 to 20 carbon atoms.

For example, A1 may be a quadrivalent aliphatic organic group having 1 to 20 carbon atoms, a quadrivalent cycloaliphatic organic group having 3 to 20 carbon atoms, or a quadrivalent aromatic organic group having 6 to 20 carbon atoms.

For example, A2 may be a divalent aliphatic organic group having 1 to 20 carbon atoms, a divalent cycloaliphatic organic group having 3 to 20 carbon atoms, or a divalent aromatic organic group having 6 to 20 carbon atoms.

According to an embodiment of the present disclosure, the polyamic acid compound may comprise a chemical structure represented by the following Formula 2. Alternatively, the polyamic acid compound may comprise a repeating unit represented by the following Formula 2.

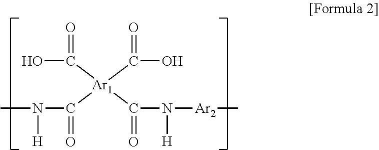

In the above Formula 2, Ar1 is a quadrivalent aromatic organic group having 6 to 20 carbon atoms, and A2 is a divalent aromatic organic group having 6 to 20 carbon atoms.

According to an embodiment of the present disclosure, the polyamic acid compound may be benzophenone polyamic acid (BPAA) having the structure of the following Formula 3, or may be naphthalene polyamic acid or pyrene polyamic acid.

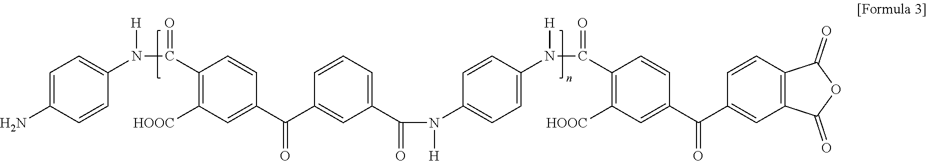

In the above Formula 3, n may be an integer of approximately 3 to 12, or approximately 5 to 10.

In the polyamic acid compound of the present disclosure, the mole ratio of the carboxylic acid group to the amide group is 1:0.5 to 1:5. According to an embodiment of the present disclosure, the mole ratio of the carboxylic acid group to the amide group may be approximately 1:0.75 to 1:3, approximately 1:0.8 to 1:2, or approximately 1:1 to 1:1.5.

When the mole ratio of the carboxylic acid group to the amide group satisfies the above-described range, it is possible to prevent the migration of lithium polysulfide eluted from the positive electrode to the negative electrode, thereby improving the life of the lithium-sulfur battery. When the mole ratio of the carboxylic acid group to the amide group is less than 1:0.5 or more than 1:5, it fails to prevent the migration of lithium polysulfide eluted from the positive electrode to the negative electrode, thereby failing to improve the life of the lithium-sulfur battery.

According to an embodiment of the present disclosure, the molar concentration of the carboxylic acid group may be approximately 5 mmol/L to 15 mmol/L, or approximately 5 mmol/L to 8 mmol/L, and the molar concentration (mmol/L) of the amide group may be approximately 8 mmol/L to 20 mmol/L, or approximately 8 mmol/L to 12 mmol/L. When the molar concentration of the carboxylic acid group and the amide group satisfies the above-described range, it may be possible to prevent the permeation of lithium polysulfide, thereby improving the battery life.

The molar concentration and the mole ratio of the carboxylic acid group to the amide group may be measured using a variety of measuring methods known in the technical field. For example, the molar concentration and the mole ratio of the carboxylic acid group to the amide group may be measured using 1H-nuclear magnetic resonance (NMR) spectrometer in the following conditions.
Instrument: AVANCE AC 400 FT NMR spectrometer (Bruker)
Measurement frequency: 400 MHZ
Measurement solvent: DMSO-d6
Measurement temperature: 25° C.

Additionally, the weight average molecular weight of the polyamic acid compound may be approximately 1,000 to 5,000 or approximately 4,000 to 5,000, and polydispersity index (PDI, a measure of molecular weight distribution) may be approximately 2.6 to 3.2 or approximately 2.7 to 2.9. When the weight average molecular weight and the PDI of the polyamic acid compound satisfies the above-described range, it may be possible to prevent the permeation of lithium polysulfide, thereby improving the battery life.

In this instance, the weight average molecular weight and the PDI may be measured using gel permeation chromatography. Specifically, the PDI may be calculated by measuring each of the number average molecular weight (Mn) and the weight average molecular weight (Mw) by gel permeation chromatography (GPC, PL GPC220, Agilent Technologies) in the following conditions, and dividing the weight average molecular weight by the number average molecular weight.
Column: PL MiniMixed B×2
Solvent: tetrahydrofuran (THF)
Flow rate: 0.3 ml/min
Sample concentration: 2.0 mg/ml
Injection amount: 10 μl.
Column temperature: 40° C.
Detector: Agilent RI detector
Standard: Polystyrene (fitted to a third degree polynominal)
Data processing: ChemStation

Additionally, according to a specific embodiment of the present disclosure, the separator for the lithium-sulfur battery may further comprise an organic/inorganic composite porous coating layer. The organic/inorganic composite porous coating layer may be located on at least one surface of the porous polymer substrate, and comprise a plurality of inorganic particles and a binder.

According to an aspect of the present disclosure, there is provided a method of manufacturing the separator for the lithium-sulfur battery, the method comprising:
preparing the porous polymer substrate having the plurality of pores; and
forming the coating layer comprising the polyamic acid compound having the carboxylic acid group and the amide group on at least one surface of the porous polymer substrate,
wherein forming the coating layer comprising the polyamic acid compound comprises:
dipping the porous polymer substrate in a first solution comprising the carboxylic dianhydride compound; and
dipping the porous polymer substrate having been dipped in the first solution in a second solution comprising the diamine compound, and
wherein the mole ratio of the carboxylic acid group to the amide group is 1:0.75 to 1:3.

According to an embodiment of the present disclosure, the polyamic acid compound may be placed in the plurality of pores simultaneously when the coating layer of the polyamic acid compound is formed on the at least one surface of the porous polymer substrate.

Hereinafter, the method of manufacturing the separator for the lithium-sulfur battery according to a specific embodiment of the present disclosure will be described.

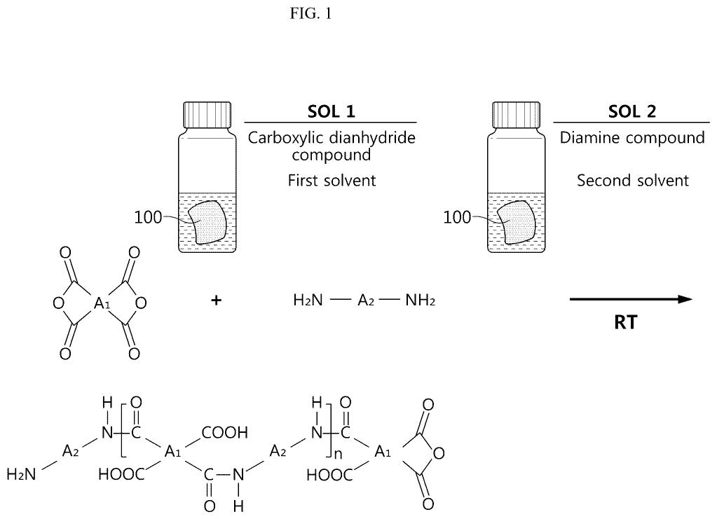

FIG. 1 is a diagram illustrating the method of manufacturing the separator for the lithium-sulfur battery according to an embodiment of the present disclosure.

Referring to FIG. 1, the porous polymer substrate 100 may be prepared. As described above, the porous polymer substrate 100 may include a porous polymer film or a nonwoven fabric comprising at least one of polymer resins such as polyolefin, polyethyleneterephthalate, polybutyleneterephthalate, polyacetal, polyamide, polycarbonate, polyimide, polyetheretherketone, polyethersulfone, polyphenylene oxide, polyphenylenesulfide and polyethylenenaphthalene.

Subsequently, the porous polymer substrate 100 may be dipped in the first solution (SOL1). For example, the porous polymer substrate 100 may be dipped in the first solution (SOL1) for approximately 40 minutes to 80 minutes. The first solution (SOL1) may comprise the carboxylic dianhydride compound, and specifically, the carboxylic dianhydride compound and a first solvent, and the first solvent may include n-methylpyrrolidone (NMP), tetrahydrofuran (THF), dimethylformamide (DMF), acetone, ethanol, water, or a compound of two or more of them. The amount of the carboxylic dianhydride compound in the first solution (SOL1) may be approximately 0.2 wt % to 3 wt %, or approximately 0.5 wt % to 1 wt %.

In an embodiment, the carboxylic dianhydride compound may comprise 3,3′,4,4′-benzophenonetetracarboxylic dianhydride, 3,3′,4,4′-diphenyltetracarboxylic dianhydride, 3,3′,4,4′-diphenylsulfonetetracarboxylic dianhydride, 2,2-bis [4-(3,4-dicarboxyphenoxy)phenyl]propane dianhydride, 1,2,3,4-benzenetetracarboxylic dianhydride, methylcyclohexene tetracarboxylic dianhydride, naphthalene-1,4,5,8-tetracarboxylic dianhydride, ethylenetetra carboxylic dianhydride, or two or more thereof.

For example, the carboxylic dianhydride compound may comprise 3,3′,4,4′-benzophenone tetracarboxylic dianhydride (BPTCDA).

The porous polymer substrate 100 having been dipped in the first solution (SOL1) may be dipped in the second solution (SOL2). For example, the porous polymer substrate 100 may be dipped in the second solution (SOL2) for approximately 40 minutes to 80 minutes. In an embodiment, the second solution (SOL2) may comprise the diamine compound, and specifically, the diamine compound and a second solvent, and the second solvent may include n-methylpyrrolidone (NMP), tetrahydrofuran (THF), dimethylformamide (DMF), acetone, ethanol, water, or a compound of two or more of them. The amount of the diamine compound in the second solution (SOL2) may be approximately 0.2 wt % to 3 wt % or approximately 0.5 wt % to 1 wt %.

In an embodiment, the diamine compound may comprise p-phenylene diamine, m-phenylene diamine, 2,2′-bis(trifluoromethyl)-4,4′-biphenyldiamine, 2,2′-dimethyl-4,4′-diaminobenzidine, 4,4′-diaminodiphenyl sulfone, 2,7-diaminofluorene, 4,4-diaminooctafluorobiphenyl, 4,4′-oxydianiline, 2,2′-dimethyl-4,4′-diaminobiphenyl, m-xylylenediamine, p-xylylenediamine, 4,4′-diaminobenzanilide, or two or more thereof.

For example, the diamine compound may comprise p-phenylene diamine (PDA).

The polyamic acid (for example, the benzophenone polyamic acid (BPAA) of FIG. 1) of the coating layer according to embodiments of the present disclosure is made via in-situ polymerization. In this instance, the process of dipping the porous polymer substrate 100 in the first solution (SOL1) and the second solution (SOL2) may be properly set based on the coating properties of the compound on the porous polymer substrate 100.

In an embodiment, after the porous polymer substrate 100 is dipped in the first solution (SOL1), the second solution (SOL2) may be injected into the porous polymer substrate 100 having been dipped in the first solution (SOL1) to dip the porous polymer substrate 100 in the second solution (SOL2).

In another embodiment, after the porous polymer substrate 100 is dipped in the first solution (SOL1), the porous polymer substrate 100 coated with the first solution (SOL1) may be taken out and then dipped in the second solution (SOL2).

Additionally, the order of dipping the porous polymer substrate 100 in the first solution (SOL1) and the second solution (SOL2) may be properly set.

In an embodiment, the porous polymer substrate 100 may be first dipped in the first solution (SOL1) and then the second solution (SOL2). In this case, the carboxylic dianhydride compound included in the first solution (SOL1) may have a larger number of phenol groups, forming I-x bonds with the porous polymer substrate 100. Accordingly, since the porous polymer substrate 100 is first dipped in the first solution (SOL1) having a larger number of phenol groups, the bonding strength between the porous polymer substrate 100 and the first solution (SOL1) may be increased.

However, the present disclosure is not limited thereto, and in another embodiment, the porous polymer substrate 100 may be first dipped in the second solution (SOL2).

Subsequently, the porous polymer substrate 100 may be cleaned and dried approximately for 24 hours to remove unreacted products remaining on the surface of the porous polymer substrate 100. For example, the porous polymer substrate 100 may be cleaned through a cleaning agent, for example, ethanol, and dried in a vacuum.

The polyamic acid of the coating layer according to embodiments of the present disclosure may be made via in-situ polymerization. For example, the carboxylic dianhydride compound having the carboxylic acid group may be first supplied to the porous polymer substrate 100, and subsequently, the diamine compound having the amine functional group may be supplied. Since the carboxylic dianhydride compound in a monomolecular state is first suppled to the porous polymer substrate 100, the carboxylic dianhydride compound may be uniformly coated into the pores of the porous polymer substrate 1000. Subsequently, the diamine compound may be supplied, causing polymerization reaction in the pores, and accordingly the polyamic acid compound may be coated in the pores more uniformly. Additionally, interfacial resistance between the coating layer and the porous polymer substrate 100 may reduce, thereby achieving higher electrochemical performance.

Additionally, the carboxylic acid group and the amide group are present in the polyamic acid of the coating layer according to embodiments of the present disclosure. In other words, polyimide may be synthesized by imidization of the polyamic acid, and the coating layer of the present disclosure comprises un-imidized polyamic acid. Accordingly, the carboxylic acid group and the amide group may be still present in the polyamic acid of the coating layer, and the separator having the coating layer may suppress the migration of lithium polysulfide, thereby increasing the life of the lithium-sulfur battery.

Hereinafter, examples will be described in detail to help better understanding of the present disclosure. However, the examples according to the present disclosure may be modified in many other forms, and the scope of the present disclosure should not be interpreted as being limited to the following examples. The examples of the present disclosure are provided to fully explain the present disclosure to persons having ordinary skill in the art.

### Example 1

### Positive Electrode

For a positive electrode active material, a carbon-sulfur composite in which carbon nanotubes (CNT): sulfur(S) were mixed at a weight ratio of 1:3 was used. The carbon-sulfur composite was mixed with a PAA binder at a weight ratio of 96:4 to prepare a positive electrode slurry, the positive electrode slurry was uniformly coated on an aluminum foil to the thickness of 300 um, dried at 55° C. and cut into 11 pi diameter to prepare a positive electrode.

### Negative Electrode and Electrolyte

For a negative electrode, lithium metal was used, and 1.0 M LiNO₃ was added to a mixed solvent of 1,3-dioxolane (DOL) and 1,2-dimethylether at a volume ratio (v/v) of 50:50 to prepare an electrolyte solution for a lithium-sulfur secondary battery.

### Separator

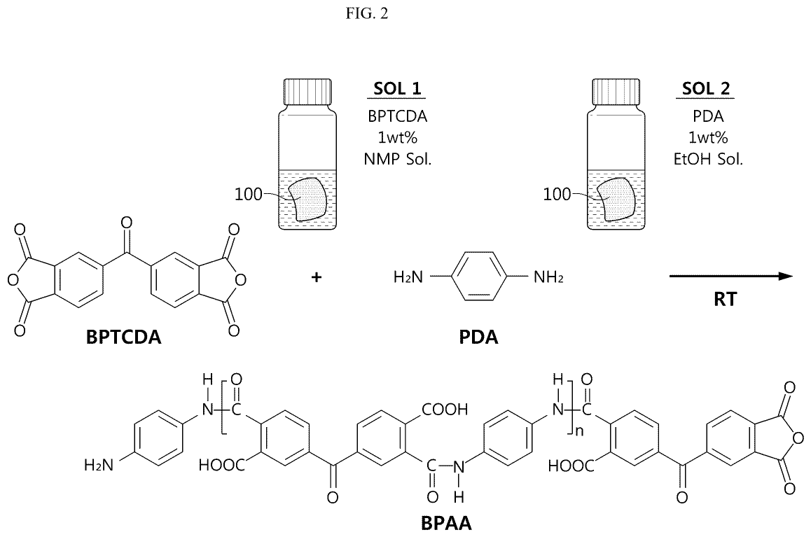

FIG. 2 shows a process of manufacturing a separator of example 1.

Referring to FIG. 2, a polyethylene porous film (Celgard 2320) as a porous polymer substrate was prepared, a first solution (SOL1) comprising 1 wt % of 3,3′4,4′-benzophenone tetracarboxylic dianhydride (BPTCDA) as a carboxylic dianhydride compound in n-methylpyrrolidone (NMP) as a first solvent was prepared, and a second solution (SOL2) comprising 1 wt % of p-phenylenediamine (p-PDA) as a diamine compound in ethanol as a second solvent was prepared.

First, the porous polymer substrate was dipped in the prepared first solution (SOL1) for 1 hour and the second solution (SOL2) was injected into the porous polymer substrate. As a result, a separator having a coating layer comprising benzophenone polyamic acid (BPAA) made via in-situ polymerization on two surfaces of the porous polymer substrate was prepared.

In this instance, in the benzophenone polyamic acid (BPAA), the molar concentration of the carboxylic acid group was 6.27 mmol/L, and the molar concentration of the amide group was 9.34 mmol/L. Thus, the mole ratio of the carboxylic acid group to the amide group was 1:1.5.

A 2032 Coin Type lithium-sulfur battery was prepared using the positive electrode, the negative electrode, the electrolyte and the separator.

### Example 2

### Positive Electrode, Negative Electrode and Electrolyte

A positive electrode, a negative electrode and an electrolyte were prepared by the same method as example 1.

### Separator

A polyethylene porous film (Celgard 2320) as a porous polymer substrate was prepared, a first solution comprising 0.5 wt % of 3,3′4,4′-benzophenone tetracarboxylic dianhydride (BPTCDA) as a carboxylic dianhydride compound in n-methylpyrrolidone (NMP) as a first solvent was prepared, and a second solution comprising 1 wt % of p-phenylenediamine (p-PDA) as a diamine compound in ethanol as a second solvent was prepared.

First, the porous polymer substrate was dipped in the prepared first solution for 1 hour, and the second solution was injected into the porous polymer substrate. As a result, a separator having a coating layer comprising benzophenone polyamic acid (BPAA) made via in-situ polymerization on two surfaces of the porous polymer substrate was prepared.

In this instance, in the benzophenone polyamic acid (BPAA), the molar concentration of the carboxylic acid group was 6.27 mmol/L, and the molar concentration of the amide group was 18.68 mmol/L. Thus, the mole ratio of the carboxylic acid group to the amide group was 1:3.

A 2032 Coin Type lithium-sulfur battery was prepared using the positive electrode, the negative electrode, the electrolyte and the separator.

### Example 3

### Positive Electrode, Negative Electrode and Electrolyte

A positive electrode, a negative electrode and an electrolyte were prepared by the same method as example 1.

### Separator

A polyethylene porous film (Celgard 2320) as a porous polymer substrate was prepared, a first solution comprising 1 wt % of 3,3′4,4′-benzophenone tetracarboxylic dianhydride (BPTCDA) as a carboxylic dianhydride compound in n-methylpyrrolidone (NMP) as a first solvent was prepared, and a second solution comprising 0.5 wt % of p-phenylenediamine (p-PDA) as a diamine compound in ethanol as a second solvent was prepared.

First, the porous polymer substrate was dipped in the prepared first solution for 1 hour, and the second solution was injected into the porous polymer substrate. As a result, a separator having a coating layer comprising benzophenone polyamic acid (BPAA) made via in-situ polymerization on two surfaces of the porous polymer substrate was prepared. In this instance, in the benzophenone polyamic acid (BPAA), the molar concentration of the carboxylic acid group was 12.54 mmol/L, and the molar concentration of the amide group was 9.34 mmol/L. Thus, the mole ratio of the carboxylic acid group to the amide group was 1:0.75.

A 2032 Coin Type lithium-sulfur battery was prepared using the positive electrode, the negative electrode, the electrolyte and the separator.

### Comparative Example 1

### Positive Electrode, Negative Electrode and Electrolyte

A positive electrode, a negative electrode and an electrolyte were prepared by the same method as example 1.

### Separator

For a porous polymer substrate, a polyethylene porous film (Celgard 2320) was used, and a separator without a coating layer comprising polyamic acid was used.

A 2032 Coin Type lithium-sulfur battery was prepared using the positive electrode, the negative electrode, the electrolyte and the separator.

### Comparative Example 2

### Positive Electrode, Negative Electrode and Electrolyte

A positive electrode, a negative electrode and an electrolyte were prepared by the same method as example 1.

### Separator

A polyethylene porous film (Celgard 2320) as a porous polymer substrate was prepared, a first solution comprising 5 wt % of 3,3′4,4′-benzophenone tetracarboxylic dianhydride (BPTCDA) as a carboxylic dianhydride compound in n-methylpyrrolidone (NMP) as a first solvent was prepared, and a second solution comprising 1 wt % of p-phenylenediamine (p-PDA) as a diamine compound in ethanol as a second solvent was prepared.

First, the porous polymer substrate was dipped in the prepared first solution for 1 hour, and the second solution was injected into the porous polymer substrate. As a result, a separator having a coating layer comprising benzophenone polyamic acid (BPAA) made via in-situ polymerization on two surfaces of the porous polymer substrate was prepared.

In this instance, in the benzophenone polyamic acid (BPAA), the molar concentration of the carboxylic acid group was 62.69 mmol/L, and the molar concentration of the amide group was 18.68 mmol/L. Thus, the mole ratio of the carboxylic acid group to the amide group was 1:0.3.

A 2032 Coin Type lithium-sulfur battery was prepared using the positive electrode, the negative electrode, the electrolyte and the separator.

### Comparative Example 3

### Positive Electrode, Negative Electrode and Electrolyte

A positive electrode, a negative electrode and an electrolyte were prepared by the same method as example 1.

### Separator

A first solution comprising 1 wt % of 3,3′4,4′-benzophenone tetracarboxylic dianhydride (BPTCDA) as a carboxylic dianhydride compound in n-methylpyrrolidone (NMP) as a first solvent was mixed with a second solution comprising 1 wt % of p-phenylenediamine (p-PDA) as a diamine compound in ethanol as a second solvent to prepare a mixed solution, and the mixed solution was coated on two surfaces of a polyethylene porous film (Celgard 3230) as a porous polymer substrate to prepare a separator having a coating layer comprising benzophenone polyamic acid (BPAA) made via ex-situ polymerization on the two surfaces of the porous polymer substrate.

In this instance, in the benzophenone polyamic acid, the molar concentration of the carboxylic acid group was 6.27 mmol/L, and the molar concentration of the amide group was 9.34 mmol/L. Thus, the mole ratio of the carboxylic acid group to the amide group was 1:1.5.

A 2032 Coin Type lithium-sulfur battery was prepared using the positive electrode, the negative electrode, the electrolyte and the separator.

### Comparative Example 4

### Positive Electrode, Negative Electrode and Electrolyte

A positive electrode, a negative electrode and an electrolyte were prepared by the same method as example 1.

### Separator

A polyethylene porous film (Celgard 2320) as a porous polymer substrate was prepared, a first solution comprising 5 wt % of 3,3′4,4′-benzophenone tetracarboxylic dianhydride (BPTCDA) as a carboxylic dianhydride compound in n-methylpyrrolidone (NMP) as a first solvent was prepared, and a second solution comprising 1 wt % of p-phenylenediamine (p-PDA) as a diamine compound in ethanol as a second solvent was prepared.

First, the porous polymer substrate was dipped in the prepared first solution for 1 hour, and the second solution was injected into the porous polymer substrate. As a result, a separator having a coating layer comprising benzophenone polyamic acid (BPAA) made via in-situ polymerization on two surfaces of the porous polymer substrate was prepared.

In this instance, in the benzophenone polyamic acid (BPAA), the molar concentration of the carboxylic acid group was 6.27 mmol/L, and the molar concentration of the amide group was 37.62 mmol/L. Thus, the mole ratio of the carboxylic acid group to the amide group was 1:6.

A 2032 Coin Type lithium-sulfur battery was prepared using the positive electrode, the negative electrode, the electrolyte and the separator.

### Evaluation Result

### 1. Measurement of Molar Concentration and Mole Ratio of Carboxylic Acid Group and Amide Group

The molar concentration and the mole ratio of the carboxylic acid group and the amide group of the polyamic acid compound included in the coating layer of the separator prepared in examples 1 to 3 and comparative examples 1 to 4 were measured using 1H-NMR spectrometer in the following conditions.
Instrument: AVANCE AC 400 FT NMR spectrometer (Bruker)
Measurement frequency: 400 MHZ
Measurement solvent: DMSO-d6
Measurement temperature: 25° C.

The results are shown in the following Table 1.

TABLE 1

| | Molar | Molar | Mole ratio | |
|---|---|---|---|---|
| | concentration | concentration | of carboxylic | Coating |
| | of carboxylic | of amide | acid | thick- |
| | acid group | group | group:amide | ness |
| | (mmol/L) | (mmol/L) | group | (nm) |
| Example 1 | 6.27 | 9.34 | 1:1.5 | 60~100 |
| Example 2 | 6.27 | 18.68 | 1:3 | 40~50 |
| Example 3 | 12.54 | 9.34 | 1:0.75 | 70~110 |
| Comparative | 0 | 0 | — | — |
| example 1 | | | | |
| Comparative | 62.69 | 18.68 | 1:0.3 | 200~350 |
| example 2 | | | | |
| Comparative | 6.27 | 9.34 | 1:1.5 | 110~150 |
| example 3 | | | | |
| (ex-situ | | | | |
| polymer- | | | | |
| ization) | | | | |
| Comparative | 6.27 | 37.62 | 1:6 | 40~50 |
| example 4 | | | | |

### 2. Life Characteristics (Cycling Characteristics) Evaluation

### Evaluation Method

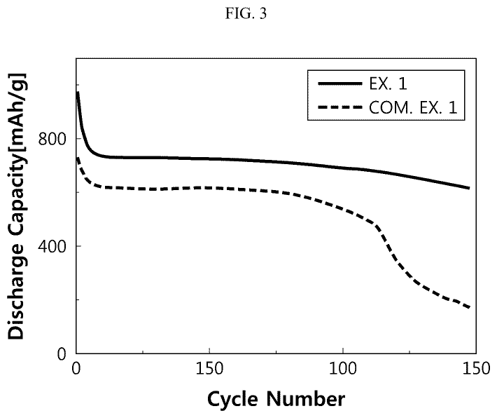

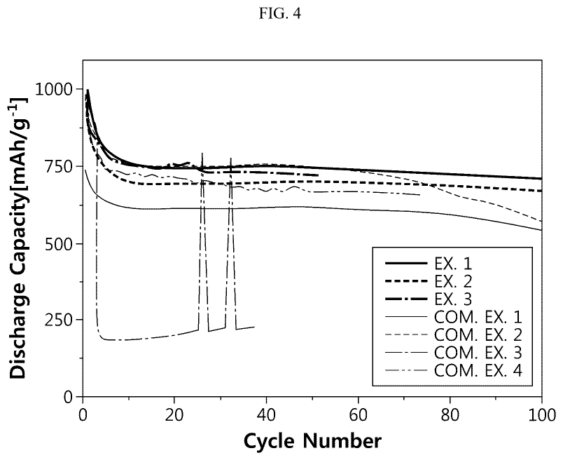

The lithium-sulfur batteries prepared in examples 1 to 3 and comparative examples 1 to 4 were charged·and discharged at 60° C. in the following conditions, and initial discharge capacity and discharge capacity after 100 cycles was evaluated.
1-3 Cycles
Charge condition: CC (constant current)/CV (constant voltage), (4.25V, 0.1C current cut-off)
Discharge condition: CC (constant current) condition 3V 0.1C
4-100 cycles
Charge condition: CC (constant current)/CV (constant voltage), (4.25V, 0.2C current cut-off)
Discharge condition: CC (constant current) condition 3V 0.2C
The results are shown in FIGS. 3 and 4.

Referring to FIG. 3, the lithium-sulfur battery according to example 1 had higher initial discharge capacity than the lithium-sulfur battery according to comparative example 1 when measured. For example, the initial discharge capacity of the lithium-sulfur battery according to example 1 was approximately 800 mAh/g, while the initial discharge capacity of the lithium-sulfur battery according to comparative example 1 was approximately 650 mAh/g.

Additionally, the lithium-sulfur battery according to example 1 had higher discharge capacity for approximately 10 cycles to 100 cycles than the lithium-sulfur battery according to comparative example 1 when measured, and after approximately 100 cycles, the lithium-sulfur battery according to example 1 maintained the discharge capacity at approximately 600 mAh/g or more, while the lithium-sulfur battery according to comparative example 1 reduced in discharge capacity down to approximately 200 mAh/g when measured.

Referring to FIG. 4, the lithium-sulfur batteries according to examples 1, 2 and 3 steadily maintained the discharge capacity of approximately 750 mAh/g or more for approximately 1 cycle to 100 cycles when measured.

In contrast, the lithium-sulfur battery according to comparative example 1 had relatively low discharge capacity of approximately 600 mAh/g for approximately 1 cycle to 100 cycles when measured, and the lithium-sulfur battery according to comparative example 2 maintained the discharge capacity of 750 mAh/g or more for approximately 70 cycles, but its discharge capacity rapidly dropped down to approximately 520 mAh/g for approximately 70 cycles to 100 cycles. Additionally, the lithium-sulfur battery according to comparative example 3 showed unstable results when measured; it had the discharge capacity of about 800 mAh/g for approximately 1 cycle to 3 cycles, and after a rapid drop, low discharge capacity of approximately 250 mAh/g or less for approximately 4 cycles to 40 cycles when measured, and the discharge capacity rapidly rose up to approximately 250 mAh/g near approximately 25 cycles and approximately 30 cycles. Additionally, the lithium-sulfur battery according to comparative example 4 maintained the discharge capacity of approximately 750 mAh/g for approximately 10 cycles, but after 70 cycles, the discharge capacity rapidly dropped, leading to failure to measure.

### 3. Thermal Stability Evaluation

### Evaluation Method

The color change and shrinkage in the separators prepared in example 1 and comparative example 1 as a function of a change in temperature between 100° C. and 150° C. was observed with the naked eye.

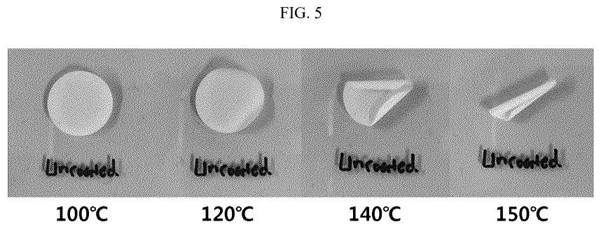

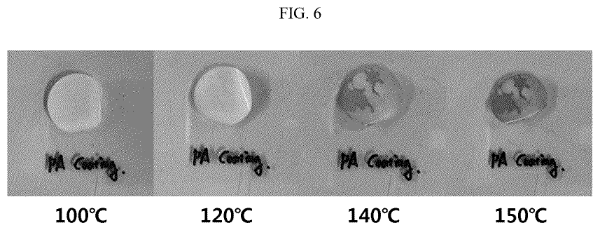

The results are shown in FIGS. 5 and 6.

Referring to FIG. 5, the separator according to comparative example 1 showed shrinkage and warpage as the temperature rises, and had no color change.

Referring to FIG. 6, the separator according to example 1 hardly showed shrinkage and warpage as the temperature rises, and showed a color change due to oxidation of the polyamic acid coated on the separator.

### 4. Determination of Suppression of Polysulfide Elution

### Evaluation Method

Each of the separators prepared in example 1 and comparative example 1 was placed at a cap of a mini vial having an opening, and an electrolyte solution comprising polysulfide was present in the mini vial. The mini vial was placed in a chamber containing an electrolyte solution (bare electrolyte) without polysulfide, and then turned upside down such that the cap contacts the electrolyte solution.

After placed untouched for 24 hours to cause diffusion through the separator, the separator was taken out and the surface of contact with the electrolyte solution without polysulfide was analyzed by UV/Vis spec. Through the analysis, whether the polysulfide in the vial eluted out through the separator was determined.

In this instance, the electrolyte solution (bare electrolyte) contains 1.0 M LiNO₃ in a mixed solvent of 1,3-dioxolane (DOL) and 1,2-dimethylether at a volume ratio (v/v) of 50:50.

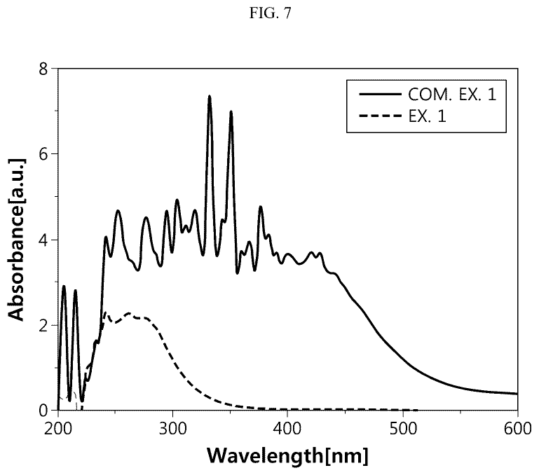

The results are shown in FIG. 7.

In the case of the separator of example 1, since elution of the polysulfide present in the mini vial was suppressed, no peak was found in UV/Vis spectrum or the intensity was low, while in the case of the separator of comparative example 1, since elution of polysulfide occurred, peaks were observed in UV/Vis spectrum and the intensity was high.

1. A separator for a lithium-sulfur battery, the separator comprising:
a porous polymer substrate having a plurality of pores; and
a coating layer on at least one surface of the porous polymer substrate, the coating layer comprising a polyamic acid compound having a carboxylic acid group and an amide group,
wherein a mole ratio of the carboxylic acid group to the amide group is 1:0.5 to 1:5.

2. The separator according to claim 1, wherein the mole ratio of the carboxylic acid group to the amide group is 1:0.75 to 1:3.

3. The separator according to claim 1, wherein the polyamic acid compound is a polymer having a unit having the carboxylic acid group and the amide group as a repeating unit.

4. The separator according to claim 1, wherein a molar concentration of the carboxylic acid group is 5 mmol/L to 15 mmol/L, and
wherein a molar concentration of the amide group is 8 mmol/L to 20 mmol/L.

5. The separator according to claim 1, wherein the polyamic acid compound is an aromatic polyamic acid compound.

6. The separator according to claim 1, wherein a polydispersity index (PDI) of the polyamic acid is 2.6 to 3.2.

7. The separator according to claim 1, wherein the polyamic acid compound having the carboxylic acid group and the amide group is present in the plurality of pores of the porous polymer substrate.

8. A lithium-sulfur battery, comprising:
a positive electrode;
a negative electrode; and
a separator according to claim 1 between the positive electrode and the negative electrode.

9. A method of manufacturing a separator for a lithium-sulfur battery, the method comprising:
preparing a porous polymer substrate having a plurality of pores; and
forming a coating layer comprising a polyamic acid compound having a carboxylic acid group and an amide group on at least one surface of the porous polymer substrate,
wherein forming the coating layer comprising the polyamic acid compound comprises:
dipping the porous polymer substrate in a first solution comprising a carboxylic dianhydride compound; and
dipping the porous polymer substrate having been dipped in the first solution in a second solution comprising a diamine compound, and
wherein a mole ratio of the carboxylic acid group to the amide group is 1:0.5 to 1:5.

10. The method of according to claim 9, wherein the polyamic acid compound is placed in the plurality of pores simultaneously when the coating layer of the polyamic acid compound is formed on the at least one surface of the porous polymer substrate.

11. The method according to claim 9, wherein the mole ratio of the carboxylic acid group to the amide group is 1:0.75 to 1:3.

12. The method according to claim 9, wherein an amount of the carboxylic dianhydride compound in the first solution is 0.2 wt % to 3 wt %, and
wherein an amount of the diamine compound in the second solution is 0.2 wt % to 3 wt %.

13. The method according to claim 9, wherein the carboxylic acid group is derived from the carboxylic dianhydride compound, and the amide group is derived from the diamine compound.

14. The method according to claim 13, wherein the carboxylic dianhydride compound comprises 3,3′,4,4′-benzophenone tetracarboxylic dianhydride, 3,3′,4,4′-diphenyltetracarboxylic dianhydride, 3,3′,4,4′-diphenylsulfonetetracarboxylic dianhydride, 2,2-bis [4-(3,4-dicarboxyphenoxy)phenyl]propane dianhydride, 1,2,3,4-benzenetetracarboxylic dianhydride, methylcyclohexene tetracarboxylic dianhydride, naphthalene-1,4,5,8-tetracarboxylic dianhydride, ethylenetetra carboxylic dianhydride, or two or more thereof, and
wherein the diamine compound comprises p-phenylene diamine, m-phenylene diamine, 2,2′-bis(trifluoromethyl)-4,4′-biphenyldiamine, 2,2′-dimethyl-4,4′-diaminobenzidine, 4,4′-diaminodiphenyl sulfone, 2,7-diaminofluorene, 4,4-diaminooctafluorobiphenyl, 4,4′-oxydianiline, 2,2′-dimethyl-4,4′-diaminobiphenyl, m-xylylenediamine, p-xylylenediamine, of 4,4′-diaminobenzanilide, or two or more thereof.

15. The method according to claim 9, wherein dipping the porous polymer substrate in the first solution and dipping the porous polymer substrate in the second solution are each performed for 40 minutes to 80 minutes.

16. The method according to claim 15, wherein the method, after dipping the porous polymer substrate in the second solution, further comprises:
cleaning the porous polymer substrate; and
drying the cleaned porous polymer substrate in a vacuum.
